(19) United States
(12) Patent Application Publication
(10) Pub. No.: US 2009/0265194 A1
(43) Pub. Date: Oct. 22, 2009

(54) UNIVERSAL BUSINESS TO MEDIA RESERVATION SYSTEM, PROCESS AND STANDARD

(75) Inventors: Jacek Waksmundzki, Warsaw (PL); Pawel Demczuk, Warsaw (PL); Lukasz Michalski, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/427,866

(22) Filed: Apr. 22, 2009

Related U.S. Application Data
(63) Continuation-in-part of application No. 12/255,513, filed on Oct. 21, 2008.
Application No. 12/255,513 is a continuation-in-part of application No. 12/255,504, filed on Oct. 21, 2008.
Application No. 12/255,504 is a continuation-in-part of application No. 12/255,484, filed on Oct. 21, 2008.
(60) Provisional application No. 60/981,760, filed on Oct. 22, 2007.
(60) Provisional application No. 60/981,752, filed on Oct. 22, 2007.
(60) Provisional application No. 60/981,744, filed on Oct. 22, 2007.

(51) Int. Cl. G06Q 10/00

(52) U.S. Cl. 705/5

(57) ABSTRACT

A computer network based universal reservation system (CNBURS) architecture, process and standard that enable reservations between one or more service providers and one or more customers relating to offers of services by the service providers. In one embodiment, the architecture of the CNBURS includes a scheduling agent system, one or more service offering systems and one or more marketplace systems. The scheduling agent system receives one or more offers of services available for reservation. Each service offering system enables service providers to define the offer(s) of services available for reservation. Each marketplace system receives the offer(s) of services from the scheduling agent system, presents the customers the offer(s) of services, receives reservation requests from the customers, and communicates received reservation requests to the scheduling agent system. The scheduling agent system communicates the offer(s) of services from the service offering system(s) to the marketplace system(s) and processes reservation requests received from the marketplace system(s).

### RELATED APPLICATION INFORMATION

This application is a continuation in-part of and claims priority from U.S. patent application Ser. No. 12/255,513 entitled “UNIVERSAL BUSINESS TO MEDIA RESERVATION SYSTEM” filed on Oct. 21, 2008, which application claims priority from U.S. Provisional Patent Application Ser. No. 60/981,760 entitled “UNIVERSAL BUSINESS TO MEDIA RESERVATION SYSTEM” filed on Oct. 22, 2007, U.S. patent application Ser. No. 12/255,504 entitled “BUSINESS TO MEDIA RESERVATION STANDARD” filed on Oct. 21, 2008, which application claims priority from U.S. Provisional Patent Application Ser. No. 60/981,752 entitled “BUSINESS TO MEDIA RESERVATION STANDARD” filed on Oct. 22, 2007, and U.S. patent application Ser. No. 12/255,484 entitled “BUSINESS TO MEDIA RESERVATION BUSINESS PROCESS” filed on Oct. 21, 2008, which application claims priority from U.S. Provisional Patent Application Ser. No. 60/981,744 entitled “BUSINESS TO MEDIA RESERVATION BUSINESS PROCESS” filed on Oct. 22, 2007, the entire disclosures of which are incorporated by reference herein in their entirety.

### FIELD OF THE INVENTION

The present invention relates generally to facilitating the reservation of services offered by service providers, and more particularly to brokering of reservations relating to services in any business domain using multiple analog and digital media.

### BACKGROUND OF THE INVENTION

The Internet and other computer networks have proven to be a useful medium for connecting service providers with persons seeking to obtain services. For example, a patient might utilize the Internet to access their doctor's office Web site to schedule an appointment, a driver might access a car rental agency's Web site via the Internet to reserve a rental car, or a diner might utilize the Internet to access a restaurant's Web site to obtain a dinner reservation. In each of the foregoing examples, the scheduling function is integrated with the system that presents information about the available service. Furthermore, access to the system that presents information about the available services may be limited to particular marketplaces. For example, the doctor's office, car rental agency's, or restaurant's Web site might be accessible via a Web portal, but not via a mobile phone portal or a digital television system. Additionally, the clients seeking services may be presented with a myriad of different scheduling systems and processes in order to reserve a variety of differing services since the clients directly interface with the service offering systems.

### SUMMARY OF THE INVENTION

Accordingly, the present invention provides for a computer network based universal reservation system (CNBURS). The CNBURS provides easy brokering of reservations relating to services between customers and service providers. A “service” may, for example, be considered an arrangement among a service provider and one or more customers by which the customer(s) receives/receive the use of one or more resources from the service provider. Use of the resource(s) may be received by the customer(s) for a scheduled period of time (e.g., for an hour, a day, a week, or the duration of a performance such as a movie, a play, or a sporting event), although it is also possible for the duration of the service to be open-ended. A “resource” may, for example, include a good that is exchanged between the service provider and the customer(s) as well as an activity that is performed for or on behalf of the customer(s). The activity may be performed by one or more individuals, one or more entities, one or more devices, or a combination of individuals, entities and/or devices. In general, a “customer” is any individual or entity that may receive a service from a service provider. The terms “customer” and “client” may be used interchangeably herein. Further, a “reservation” refers to any activity involving scheduling the delivery of a service. A “service provider” may be any individual or entity that possesses resources and is capable of providing the use of those resources to customers. Where the service provider owns a resource, ownership of the resource may be maintained by the service provider during the service.

The present invention provides universality by allowing for the inclusion of every customer who desires to participate and every service provider who desires to participate through every analog and digital media (e.g. newspaper, billboard, Internet, ITV, cell phone, PDA, etc.) and through multiple marketplaces that desire to participate (e.g., universal portals, linked services portals, specialty portals, media portals, etc.).

The CNBURS includes a number of components that communicate with one another via computer networks. The computer networks may, in general, be any public network(s), any private network(s), or any combination of public and private network(s) that provide for the communication of data between devices connected to the network(s). Examples of such computer network(s) include the Internet, private switched telephone networks, cellular telephone networks, cable and satellite television networks, wireless networks, and the like.

The present invention includes various aspects and features. In one aspect, a computer network based universal reservation system enabling one or more customers to reserve services offered by one or more service providers comprises a scheduling agent system, one or more services offering systems, and one or more marketplace systems. The scheduling agent system includes at least one processor, at least one computer network connection and computer program instructions executable by the processor(s) included in the scheduling agent system that enable the scheduling agent system to receive one or more offers of services available for reservation via the computer network connection(s) included in the scheduling agent system. Each service offering system includes at least one processor, at least one computer network connection and computer program instructions executable by the processor(s) included in each service offering system that enable service providers to define one or more offers of services available for reservation with customers and make the one or more offers of service available to the scheduling agent via the computer network connection(s) included in each service offering system. In this regard, an offer of services includes a delegation by the service provider that specifies whether the scheduling agent system is delegated authority on behalf of the service provider to complete reservations with customers relating to the offer of services. Each marketplace system is associated with a marketplace and includes at least one processor, at least one computer network connection and computer program instructions executable by the processor(s) included in each marketplace system that enable each marketplace system to receive via the computer network connection(s) the offer(s) of services from the scheduling agent system, present the customers the offer(s) of services, receive reservation requests from the customers relating to the offer(s) of services, and communicate received reservation requests to the scheduling agent system. The computer program instructions executable by the processor(s) of the scheduling agent system further enable the scheduling agent system to conduct a reservation process wherein the scheduling agent system communicates the offer(s) of services from the service offering system(s) to the marketplace system(s) to provide a connection among the service providers and marketplaces by which marketplaces are provided schedulable time periods relating to services from multiple service providers and wherein the scheduling agent system processes reservation requests received from the marketplace system(s) and to transform the requests into reservations for services provided by the service providers to the customers.

In another aspect, a method for facilitating reservations of services between customers and service providers includes the step of conducting an offer construction process involving one or more service providers and a scheduling agent supplier. The one or more service providers offer services available for reservation by customers using a services offering system and the scheduling agent supplier provides a scheduling agent system to which offers of services are communicated. The services offering system includes at least one processor, at least one computer network connection and computer program instructions executable by the processor(s) included in the services offering system, and the scheduling agent system includes at least one processor, at least one computer network connection and computer program instructions executable by the processor(s) included in the scheduling agent system that enable the scheduling agent to receive the offers of services via the computer network connection(s). The method also includes the step of conducting a marketplace construction process involving one or more marketplace suppliers and the scheduling agent supplier. The one or more marketplace suppliers provide one or more marketplace systems and one or more media for customer communication with the marketplace systems. Each marketplace system is associated with a marketplace and includes at least one processor, at least one computer network connection and computer program instructions executable by the processor(s) included in the marketplace system that enable the marketplace system to receive via the computer network connection(s) the offers of services from the scheduling agent system, present the customers the offers of services, receive reservation requests from the customers relating to the offers of services, and communicate received reservation requests to the scheduling agent system. The method further includes the step of conducting a reservation process wherein a single scheduling agent system operating separately from the marketplace system(s) provides connection among the service providers and marketplaces by which marketplaces are provided schedulable time periods relating to services from multiple service providers and wherein the single scheduling agent system processes reservation requests from customers relating to services offered by the service provider(s) on the marketplace system(s) and presented to the customers through the one or more media to transform the requests into reservations for services provided by the service providers to the customers.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1A is a block diagram showing one embodiment of a computer network based universal reservation system presenting involved actors and components;

FIG. 1B is a block diagram showing a business environment with four groups of actors and three component types provided in accordance with the B2M reservation standard;

FIG. 2 is a block diagram showing the architecture of one example of a computing system that may be utilized in implementing various components of the computer network based universal reservation system; and

FIG. 3 shows one embodiment of a computer network based universal reservation system development process.

### DETAILED DESCRIPTION

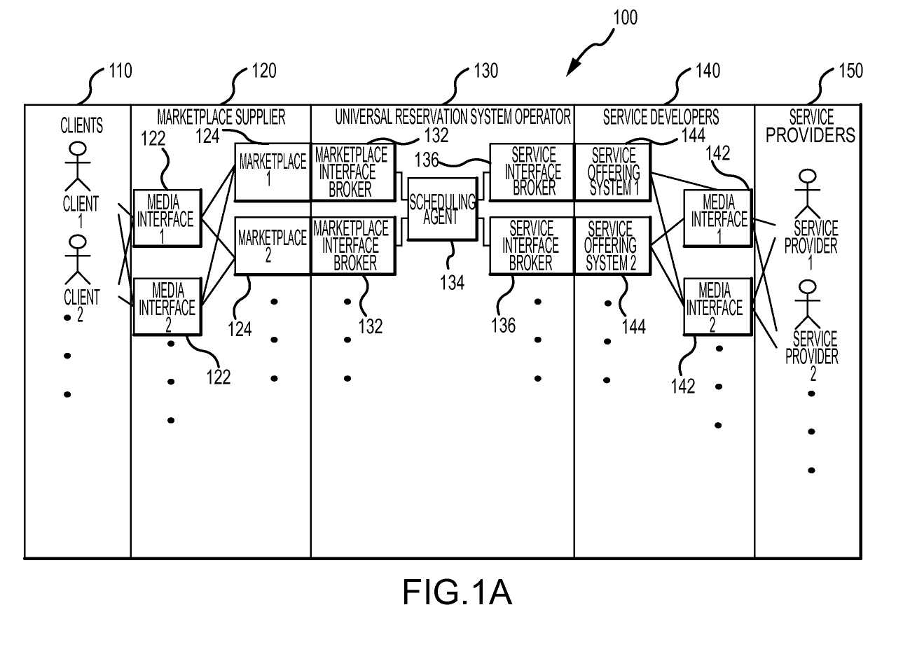

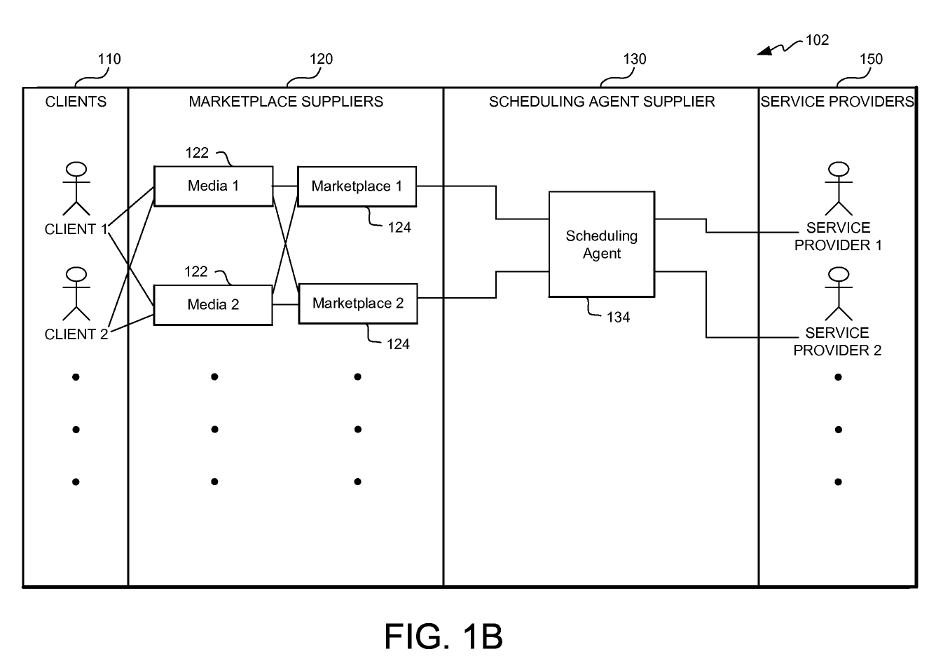

FIG. 1A shows one embodiment of a computer network based universal reservation system (CNBURS) 100. The CNBURS 100 conforms to the business to media (B2M) reservation standard. In general, the B2M reservation standard specifies a standard that provides for the visualization of, and the renting/scheduling of services, simultaneously, in real time, and over multiple analog and digital media in multiple analog and digital marketplaces.

As shown in FIG. 1B, the B2M reservation standard specifies a model 102 that includes four (4) groups of actors and three (3) component types. The four groups of actors interacting in this model are: clients 110, marketplace suppliers 120, the scheduling agent supplier 130 and service providers 150. Three component types used in the model are: media 122, marketplaces 124 and the scheduling agent 134. In accordance with the B2M reservation standard, the various actors and components undertake various roles and/or have various interactions. The marketplaces 124 may be implemented in any analog and/or digital forms where services are available through any media 122 to the clients 110, including, for example, in one embodiment as computer network enabled computer systems. The scheduling agent 134 may be implemented in any machine implemented form capable of processing all kinds of reservations (e.g. renting, reserving, scheduling, etc.) of all kinds of services, including, for example, in one embodiment as a computer network enabled computer system. The scheduling agent 134 has the capability to complete reservations from multiple marketplaces 124.

### B2M Reservation Standard Roles

The role of the clients 110 is to request reservations (e.g., reserve/schedule) of services available on multiple marketplaces 124 through multiple media 122. There may be one, two or more clients 110.

The role of marketplace suppliers 120 is to provide marketplaces 124 in any area of perceived market need (e.g. computer shops, car shops, hair-dressers, ski rentals, hotels, etc.) in forms suitable to the clients 110. There may be one or more marketplace suppliers 120. The marketplaces 124 may be implemented in numerous machine implemented forms (e.g. WWW sites, DTV programs, mobile portals, etc.). Marketplace suppliers 120 also provide media 122 for communication by clients 110 with marketplaces 124. Media 122 include analog (e.g. analog phone, printed materials, etc.) and/or digital (e.g. Internet, mobile phones, digital TV, etc.) types.

The role of marketplaces 124 is to offer services available from the scheduling agent 134 to the clients 110 and to mediate in reservations of those services between the scheduling agent 134 and the clients 110. One, two or more marketplaces 124 may be provided by the marketplace suppliers 120.

The role of the media 122 is to enable one-way (e.g. billboards, newspapers, etc.) and two-way (e.g. Internet, mobile phones, etc.) communication between clients 110 and marketplaces 124. One, two or more media 122 may be provided by the marketplace suppliers 120.

The role of the scheduling agent supplier 130 is to provide the scheduling agent 134 in any needed machine implemented form (e.g. one or more computer systems). The scheduling agent 134 is responsible for exchanging information between service providers 150 and marketplaces 124 in both directions and is responsible for handling reservations on behalf of the service providers 150, if service providers 150 decide to delegate reservation handling to the scheduling agent 134.

The role of the scheduling agent 134 is to pass a service offer from the service providers 150 to the marketplaces 124 and inform service providers 150 about reservation requests from the marketplaces 124.

The role of service providers 150 is to have an offer of services, to give an access to those services to the scheduling agent 134 and to handle reservations incoming from scheduling agent 134 or (optionally) fully delegate reservations to the scheduling agent 134. There may be one, two or more service providers 150.

### B2M Reservation Standard Interactions

The B2M reservation standard provides a business environment where three main interactions (Service offer construction, Marketplace construction, and Reservation process), which are described below, take place:

B2M Reservation Standard Service Offer Construction

The service provider 150 defines services, which will be available for reservations and describes those services by naming their features such as: price, needed resources, place, etc. The service provider 150 creates delegations by deciding which services reservations the service provider 150 will handle and which will be handled by the scheduling agent 134. The service provider 150 adapts communication methods, provided by the scheduling agent supplier 130 for two-way communication between the service provider 150 and the scheduling agent 134. When communication channels are established, the service provider 150 places his offer and his delegations with the scheduling agent 134. The service provider 150 does not have to be connected permanently to the scheduling agent 134, but in the case that service provider 150 is not connected permanently to the scheduling agent 134, the services without delegations may not be available to the clients 110. Services without delegations may be available only when the service provider 150 is connected to the scheduling agent 134.

B2M Reservation Standard Marketplace Construction

The marketplace supplier 120 establishes communication methods with the scheduling agent 134 and receives information about business domains available to the scheduling agent 134. The marketplace supplier 120 chooses at least one business domain and makes services from this domain available to the clients 110 through at least one media 122. The marketplace 124 may stay permanently connected with the scheduling agent 134 and presents to the clients 110 up to date offers with available services only.

B2M Reservation Standard Reservation Process

The client 110 gets the information about the offers available on a marketplace 124 through a chosen media 122 that enables marketplace 124 to client 110 communication. If the chosen media 122 also supports a return communication channel, the client 110 uses it for making a reservation of a chosen service. When the chosen media 122 do not have a return channel, the client 110 uses other available media 122 with return communication capabilities to make this reservation. As the marketplace 124 stays connected to the scheduling agent 134, the reservation request is transmitted immediately from the marketplace 124 to the scheduling agent 134. If the scheduling agent 134 has been given delegation for the chosen services, it accepts or refuses the reservation. If the scheduling agent 134 has not been given delegation for the chosen services, the scheduling agent 134 informs the service provider 150 about the reservation request and the services provider 150 decides whether to accept it or refuse it. When the reservation status is set, the scheduling agent 134 informs the marketplace 124 about this status and the marketplace 124 makes this information available to the client 110.

Referring again to FIG. 1A, the CNBURS 100 represents one possible implementation of the B2M reservation standard implemented in digital and computer network enabled technology. As illustrated in FIG. 1A, CNBURS 100 includes five (5) groups of actors and six (6) types of components. The five groups of actors are: clients 110, marketplace suppliers 120, the universal reservation system operator 130, service developers 140 and service providers 150. The six types of components are: media interface 122 and 142, marketplace 124, the marketplace interface broker 132, the scheduling agent 134, the service interface broker 136 and the service offering system 144. The characteristics and roles of the various components of and actors involved in the CNBURS 100 are described below.

### CNBURS 100 Components

The media interfaces 122, 142 are a set of tools enabling communication through one-way media (e.g. billboards, newspapers, radio, analog TV, etc.) and two-way media (e.g. Internet, mobile phones, digital TV, etc.). One-way communication media are used by clients 110 to get information from marketplaces 124, and two-way communication media are used between service providers 150 and service offering systems 144 as well as between clients 110 and marketplaces 124. In this regard, the media interfaces 142 operated by the service developers 140 should provide for two-way communication, whereas the media interfaces 122 operated by the marketplace suppliers 120 may provide for one-way or two-way communication. Sets of tools are different for digital media and analog media. Tools for digital media include, for example, web applications, digital television (DTV) applications, mobile web applications, local applications (e.g., graphical user interfaces), and the like. Tools for analog media include, for example, graphics, texts, sounds, and the like.

The marketplace component 124 is a computer network enabled computer system where services are available through media interfaces 122 to the clients 110. In this regard, marketplaces 124 may also be referred to herein as marketplace systems 124. The marketplace 124 offers services available at the scheduling agent component 134 to the clients 110 and mediates within the reservation process of those services between the scheduling agent 134 and the clients 110. The marketplace 124 is a separate computer system from the scheduling agent 134 and uses the marketplace interface broker component 132 to communicate with the scheduling agent 134.

The marketplace interface broker (MIB) 132 is a tool enabling integration of marketplaces 124 with the scheduling agent 134. The MIB 132 provides functionality dependent upon different kinds of marketplaces 124 (e.g. different technologies, different business domains, different business functionality, etc.) and the ability to be connected to the scheduling agent 134. The MIB 132 communicates with scheduling agent 134 through a computer network (not shown).

The scheduling agent 134 is a computer network enabled computer system capable of processing all kinds of reservations (e.g. renting, reserving, scheduling, etc.) of all kinds of services on behalf of a service provider 150 and the handling of those reservations between marketplace interface brokers 132 and service interface brokers 136. In this regard, the scheduling agent 134 may also be referred to herein as the scheduling agent system 134. The scheduling agent 134 passes the services offer from the service offering systems 144 (placed there by service providers 150) to the marketplaces 124 and informs service providers 150 through the service offering systems 144 about reservation requests from the marketplaces 124. The scheduling agent 134 is connected via a computer network (not shown) to one or more service offering systems 144 (the number of service offering systems 144 is unlimited) using service interface brokers 136 and to one or more marketplaces 124 (the number of marketplaces 124 is unlimited) using marketplace interface brokers 132. There is only one scheduling agent 134 in the CNBURS 100 which is capable of serving every type of business domain.

The service interface broker (SIB) 136 is a tool enabling integration of service offering systems 144 with the scheduling agent 134. The SIB 136 provides functionality dependent upon different kinds of service offering systems 144 (e.g. different technologies, different business domains, different logical approaches, etc.) and the ability to be connected to the scheduling agent 134. The SIB 136 communicates with the scheduling agent 134 through a computer network (not shown).

The service offering system 144 is a computer network enabled computer system where services are defined and managed by service providers 150. In the CNBURS 100 of FIG. 1A, service providers 150 define and manage services with a service offering system 144 through media interfaces 142 (e.g. using web applications, DTV applications, mobile web applications, local applications). The service offering system 144 makes services offered by service providers 150 available to the scheduling agent 134 and mediates in the reservation process of those services between the scheduling agent 134 and the service provider 150. The service offering system 144 is a separate computer system from the scheduling agent 134 and uses the service interface broker 136 to communicate with the scheduling agent 134.

### CNBURS Actors

The role of clients 110 is to rent/reserve/schedule/etc. services available on multiple marketplaces 124 through multiple media 122. Although two clients 110 are depicted in FIG. 1A, there are no limits on the number of clients 110 using CNBURS 100.

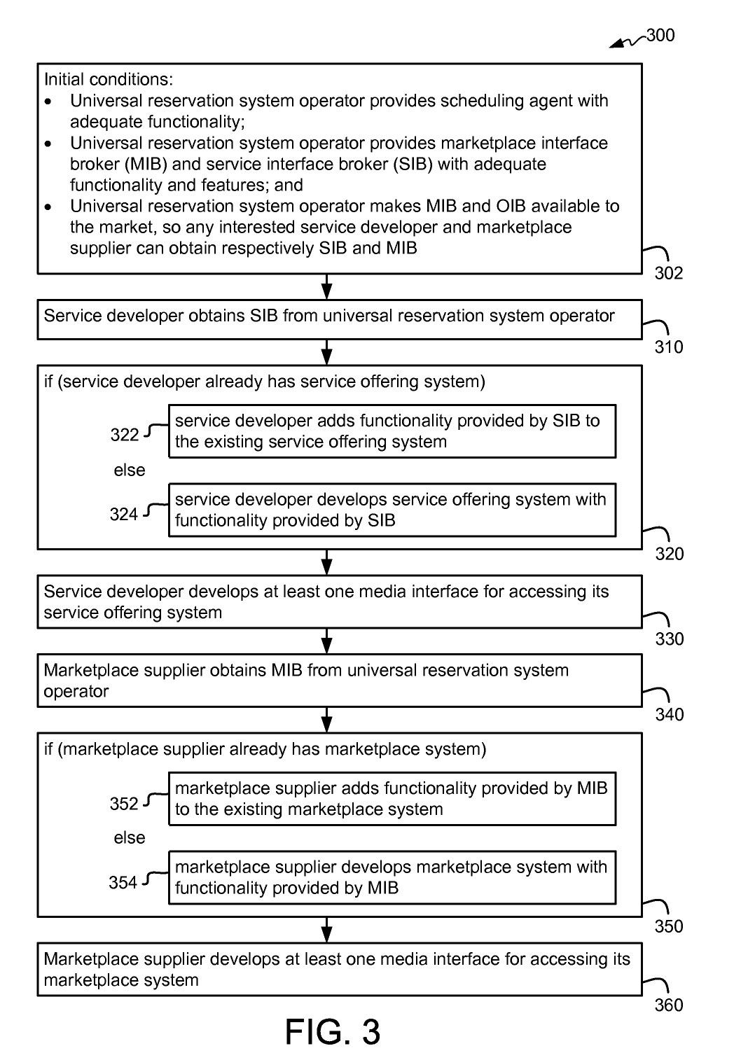

The role of marketplace suppliers 120 is to provide marketplaces 124 in any area of perceived market need (e.g. computer shops, car shops, hair-dressers, ski rentals, hotels, etc.). Marketplace suppliers 120 use marketplace interface brokers 132 to integrate marketplaces 124 with the scheduling agent 134. One exemplary process of integrating marketplaces 124 with the scheduling agent 134 is described herein in connection with FIG. 3.

The marketplaces 124 can be unique (e.g. auto repair appointment reservations, hotel reservations or car purchase reservations, etc.), linked (e.g. hotel, restaurant and rental car reservations) or universal (every registered service provider, limited only by the parameters of the client search). Marketplace suppliers 120 also provide media interfaces 122 for communication between marketplaces 124 and clients 110. The media used for communication can be analog (e.g. newspapers, billboards, etc.) and/or digital (e.g. Internet, mobile phones, digital TV, etc.). It is a choice of marketplace suppliers 120 what communication possibilities and which media are available for clients. An unlimited number of marketplaces 124 can be created and an unlimited number of marketplace suppliers 120 can be involved in the CNBURS 100.

The role of the scheduling agent supplier 130 is to provide the scheduling agent 134, which is responsible for exchanging information between service offering systems 144 and marketplaces 124 in both directions and is responsible for completing reservations on behalf of a service provider 150, if the service provider 150 decides to delegate reservation handling to the scheduling agent 134.

Service developers 140 utilize the service interface broker 136 to develop and configure the service offering system 144 for a specific category of services (e.g. ski rental equipment reservations or ski equipment purchase reservation), to define delegations to the scheduling agent 134, and to name specific existing marketplaces 124 where the offer will be available to the clients 110. One exemplary process of integrating service offering systems 144 with the scheduling agent 134 is described herein in connection with FIG. 3.

The delegations to the scheduling agent 134 may be sufficient to allow the scheduling agent 134 to complete the reservation. The scheduling agent 134 may provide a universal service code (USC) associated with each service, which facilitates the use of one-way media for presenting those services to the clients 110 on the marketplaces 124. However, a USC may not be required to use one-way media. In general, a USC is a unique sequence of letters, numerals, symbols or combination of letters, numerals and/or symbols that is associated with a particular service. USCs (in the context of reserving services) are more specifically described in a separate United States patent application filed contemporaneously herewith entitled “UNIVERSAL SERVICE CODE FOR RESERVATIONS” (which application claims priority from U.S. patent application Ser. No. 12/255,383 filed Oct. 21, 2008, which application claims priority from U.S. Provisional Application No. 60/981,725 filed Oct. 22, 2007), the entire disclosure of which is incorporated by reference herein.

There can be an unlimited number of service offering systems 144 and an unlimited number of service developers 140 can be involved in the CNBURS 100.

The role of service providers 150 is to have an offer of services, to give an access to those services to the scheduling agent 134 and to handle reservations incoming from the scheduling agent 134 or (optionally) fully delegate reservations to the scheduling agent 134. Although two service providers 150 are depicted in FIG. 1A, there are no limits on the number of service providers 150 using CNBURS 100.

### CNBURS Interactions

The CNBURS 100 undertakes a number of actions/processes including, for example, offer construction, marketplace construction, and reservation processing.

CNBURS Offer Construction

The service developer 140 develops a service offering system 144 and, by using the service interface broker 136, integrates this service offering system 144 with the scheduling agent 134. The service provider 150 uses the service offering system 144 to define services, which will be available for reservations and describes those services in the service offering system 144 by defining their features such as, for example: price, needed resources, place, availability, etc. The service provider 150 may also include information indicating whether the scheduling agent 134 is delegated authority to complete reservations relating to an offer of the services. Using available features in the service offering system 144, the service provider 150 creates delegations by deciding which service reservations will be handled by the service provider 150 and which will be handled by the scheduling agent 134. When the service provider 150 decides that the offer is ready, the service provider 150 commands the service offering system 144 to place the offer with the scheduling agent 134. The service offering system 144 does not have to be connected permanently to the scheduling agent 134, but when not connected the services without delegations will not be available to the clients 110. Services without delegations are available only when the service offering system 144 is connected to the scheduling agent 134.

CNBURS Marketplace Construction

The marketplace supplier 120, using the marketplace interface broker 132 integrates a given marketplace 124 with the scheduling agent 134. The marketplace supplier 120 chooses at least one business domain from the domains available in the scheduling agent 134 and develops at least one media interface 122 through which clients 110 will have an access to the services from this domain. The marketplace 124 stays permanently connected through a computer network (not shown) with the scheduling agent 134 and presents to the clients 110 up to date offers with available services only.

CNBURS Reservation Processing

The client 110 gets the information about the offer and its availability on a marketplace 124 through a chosen media interface 122, which enables marketplace to client-directed communication. If this media interface 122 also supports a return communication channel (e.g., it is two-way), the client 110 uses it for completing the reservation for a chosen service. When the chosen media interface 122 does not have a return channel, the client 110 uses another available media interface 122 with return communication capabilities to complete this reservation. As the marketplace 124 stays connected to the scheduling agent 134, the reservation request is transmitted, over a computer network (not shown), immediately from the marketplace 124 to the scheduling agent 134. If the scheduling agent 134 was given delegation for the chosen services, it accepts or refuses the reservation. If not, the scheduling agent 134 (over a computer network) informs the service offering system 144 and the service provider 150 about the reservation request. The service provider 150 decides whether to accept it or refuse it. When the reservation status is set, the scheduling agent 134 (over a computer network) informs the marketplace 124 about this status and the marketplace 124 makes this information available to the client 110 through a given media interface 122.

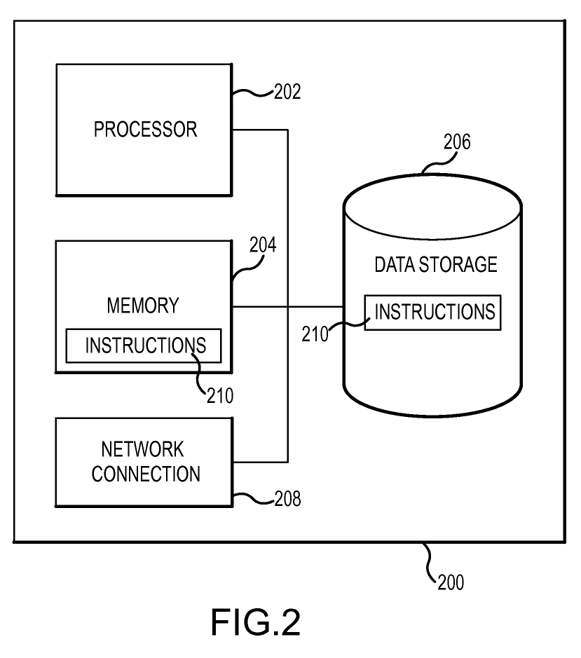

Referring now to FIG. 2, one embodiment of an exemplary computing system 200 that may be utilized to implement one or more of the various components of the CNBURS 100 is shown. For example, scheduling agent 134, the service offering systems 144, and the marketplaces 124 may be implemented using separate computing systems 200 such as depicted in FIG. 2. Computing system 200 depicted in FIG. 2 is not the only computing system architecture that be utilized to implement various components of CNBURS 100 and differently configured computing systems or the like may be utilized. Further, multiple computing systems 200 such as depicted in FIG. 2 may be utilized to implement a single component within the CNBURS 100. For example, the scheduling agent 134, a service offering system 144 and/or a marketplace 124 may comprise two or more computing systems (200) in communication with one another via, for example, a local area network (LAN) connection.

Computing system 200 includes, among other components, a processor 202, memory 204, a data storage device 206 (e.g., a hard drive), and a network connection device 208 (e.g., an Ethernet card, a WiFi network card, a modem or the like). Computing system 200 may include additional components that are not illustrated in FIG. 2 including, for example, a power supply, an input device (e.g., a keyboard, a pointing device), and an output device (e.g., a display). The processor 202 executes computer program instructions 210 stored in memory 204 and/or on the data storage device 206 that enable the computing system 200 to provide the desired functionality of the component within the CNBURS 100 that computing system 200 is be used to implement.

The computer program instructions 210 may, for example in the case of computing system 200 being used to implement a marketplace 124, include instructions to provide the various functionalities of the marketplace 124 including offering services available at the scheduling agent 134 to the clients 110 via the media interfaces 122 and mediating in the reservation process of such services between the scheduling agent 134 and the clients 110. In this regard, the computer program instructions 210 executable by the processor 202 of the computing system 200 may also implement some portion or the entirety of the marketplace interface broker 132 corresponding with the marketplace 124.

The computer program instructions 210 may, for example in the case of computing system 200 being used to implement the scheduling agent 134, include instructions enabling the computing system 200 to provide the various functionalities of the scheduling agent 134 including passing services offers from the service offering systems 144 to the marketplaces 124, informing service providers 150 through the service offering systems 144 about reservation requests from the marketplaces 124, and scheduling (when delegated authority) on behalf of the service providers 150 all kinds of reservations by clients 110 of all kinds of services. In this regard, the computer program instructions 210 executable by the processor 202 of the computing system 200 may also implement some portion or the entirety of the marketplace interface brokers 132 and the service interface brokers 136.

The computer program instructions 210 may, for example in the case of computing system 200 being used to implement a service offering system 144, include instructions to provide the various functionalities of the service offering system 144 including enabling service providers 150 to define and manage services through media interfaces 142, making the services offered by service providers 150 available to the scheduling agent 134, and mediating in the reservation process between the scheduling agent 134 and the service providers 150. In this regard, the computer program instructions 210 executable by the processor 202 of the computing system 200 may also implement some portion or the entirety of the service interface broker 136 corresponding with the service offering system 144.

Referring now to FIG. 3, one embodiment of a process 300 of developing a CNBURS is illustrated. The CNBURS development process 300 combines interactions of three (3) groups of actors and six (6) component types (see FIG. 1A). Component types used in this process include:
A media interface 122, 142 is a set of all tools (e.g. php-html scripts, OpenTV applications, etc.) needed to support client 110 to marketplace 124, marketplace 124 to client 110, service provider 150 to service offering system 144, and service offering system 144 to service provider 150 directed communication through digital media (e.g. mobile phone with an Internet browser, PC with an Internet browser, etc.). The media interface 122 is also a set of tools (e.g. graphics, texts, etc.) needed to enable marketplace 124 to client 110 directed communication through analog media (e.g. billboards, newspapers, etc.).
A marketplace 124 is a computer network enabled computer system where services are available through media interfaces 122 to the clients 110. In this regard, marketplaces 124 may also be referred to herein as marketplace systems 124.
A marketplace interface broker (MIB) 132 is a tool integrating marketplaces 124 with a scheduling agent 134. The MIB 132 provides functionality enabling different kinds of marketplaces 124 to be connected to the scheduling agent 134.
A scheduling agent 134 is a computer network enabled computer system capable of processing reservations of services on behalf of a service provider 150 and handling reservations between marketplace interface brokers 132 and service interface brokers 136. In this regard, the scheduling agent 134 may also be referred to herein as the scheduling agent system 134. The scheduling agent 134 is connected via a computer network (not shown) to one or more service offering systems 144 using service interface brokers 136 and to marketplaces 124 using marketplace interface brokers 132.
A service interface broker (SIB) 136 is a tool integrating service offering systems 144 with the scheduling agent 134. The SIB 136 provides functionality enabling different kinds of service offering systems 144 to be connected to the scheduling agent 134.
A service offering system 144 is a computer network enabled computer system where services are defined and managed by service providers 150 through media interfaces 142.
   The actors cooperating in the process of developing CNBURS include:
A universal reservation system operator 130 that is the provider of three components: the scheduling agent 134, the marketplace interface broker 132 and the service interface broker 136.
A marketplace supplier 120 that is the developer of one or more marketplaces 124 and one or more media interfaces 122.
A service developer 140 that is the developer of one or more service offering systems 144 and one or more media interfaces 142.

CNBURS development may proceed in accordance with a process 300 such as depicted in FIG. 3. When the CNBURS development process begins, there are several initial conditions 302 including: (1) the universal reservation system operator 130 provides the scheduling agent 134 with adequate functionality; (2) the universal reservation system operator 130 provides the MIB 132 and the SIB 136 with the adequate functionality and features; and (3) the universal reservation system operator 130 makes the MIB 132 and the SIB 136 available to the market, so any interested service developer 140 and marketplace supplier 120 can obtain, respectively, the SIB 136 and the MIB 132.

With the initial conditions 302 satisfied, one embodiment of the CNBURS development process 300 proceeds in the following manner. In a first step 310, the service developer 140 obtains the SIB 136 from the universal reservation system operator 130. In a second step 320 the service developer undertakes one of two sub-steps. If the service developer 140 already has a service offering system 144, the service developer 140 undertakes sub-step 322 wherein the service developer 140 adds functionality provided by the SIB 136 to the existing service offering system 144; else, the service developer 140 undertakes sub-step 324 wherein the service developer 140 develops a service offering system 144 with functionality provided by the SIB 136. In a third step 330, the service developer 140 develops at least one media interface 142 for accessing its service offering system 144.

In a fourth step 340, the marketplace supplier 120 obtains the MIB 132 from the universal reservation system operator 130. In a fifth step 350, the marketplace supplier 120 undertakes one of two sub-steps. If the marketplace supplier 120 already has a marketplace system 124, the marketplace supplier 120 undertakes sub-step 352 wherein the marketplace supplier 120 adds functionality provided by the MIB 132 to the existing marketplace system 124; else, the marketplace supplier 120 undertakes sub-step 354 wherein the marketplace supplier 120 develops the marketplace system 124 with functionality provided by the MIB 132. In a sixth step 360, the marketplace supplier 120 develops at least one media interface 122 for accessing its marketplace system 120.

In other embodiments of the CNBURS development process, the order of one or more of the aforementioned steps (310-360) may be arranged in a different manner. For example, steps undertaken by the service developer 140 (e.g., steps 310-330) may proceed in parallel with the steps undertaken by the marketplace supplier 120 (e.g., steps 340-360) or after the steps undertaken by the marketplace supplier 120. Regardless of the order in which the steps are arranged, the CNBURS 100 starts to work at its full functionality when at least one service developer 140 and at least one marketplace supplier 120 fulfill their respective activities of the CNBURS development process 300.

### Ownership of CNBURS

Actors (e.g., the universal reservation system operator 130, marketplace suppliers 120 and service developers 140) participating in development of CNBURS 100 partially own the system 100 by owning its specified elements. Three groups of actors and their components are listed below:
The universal reservation system operator 130 owns the scheduling agent system 134, the service interface broker 136 and the marketplace interface broker 132,
Each service developer 140 owns at least one service offering system 144 and at least one media interface 142, and
Each marketplace supplier 120 owns at least one marketplace system 124 and at least one media interface 122.
   While there is only one universal reservation system operator 130, the number of service developers 140 and marketplace suppliers 120 participating in developing a CNBURS 100 is not limited.

### Roles and Responsibilities

The role of the universal reservation system operator 130 in the CNBURS development process 300 includes:
supplying marketplace suppliers 120 and service developers 140, respectively, with MIBs 132 and SIBs 136;
assuring error-free and secure communication between provided MIBs 132 and SIBs 136;
providing the scheduling agent 134 which will operate efficiently and reliably; and
providing the functionality that satisfies marketplace suppliers 120 and service developers 140 needs according to the CNBURS 100.

The role of marketplace suppliers 120 includes:
building marketplaces 124 in any area of perceived market need (e.g. auto parts reservation, hair-dressers, ski rentals, hotels, etc.);
establishing the tailored user interfaces for marketplaces 124;
linking or excluding service domains in order to improve the client experience on a given marketplace 124; and
providing access to marketplaces 124 to the clients 110 through required analog and digital media by media interfaces 122 (e.g. newspapers, billboards, cell phones, WWW sites, digital TV applications, etc.).

The role of service developers 140 includes:
building service offering systems 144 in any perceived need business domain (e.g. computer purchase reservation, auto parts, hair-dressers, ski rentals, hotels, etc.);
establishing the tailored user interfaces for service offering systems 144;
developing service provider's 150 reservation delegations within service offering systems 144;
developing functionality of assigning service provider's 150 offer to a unique universal service code;
linking to service offering systems 144 any other domain-specific tools (e.g. patient medical records, restaurant table configuration, etc.); and
providing access to service offering systems 144 to the service providers 150 through required digital media by media interfaces 142 (e.g. cell phone applications, WWW applications, digital TV applications, computer network enabled local applications, etc.).

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A computer network based universal reservation system enabling one or more customers to reserve services offered by one or more service providers, said system comprising:
a scheduling agent system including at least one processor, at least one computer network connection and computer program instructions executable by said at least one processor included in said scheduling agent system that enable said scheduling agent system to receive one or more offers of services available for reservation via the at least one computer network connection included in the scheduling agent system;
one or more service offering systems, each said service offering system including at least one processor, at least one computer network connection and computer program instructions executable by said at least one processor included in said service offering system that enable service providers to define one or more offers of services available for reservation with customers and make the one or more offers of service available to the scheduling agent via the at least one computer network connection included in said service offering system, wherein an offer of services includes a delegation by the service provider that specifies whether said scheduling agent system is delegated authority on behalf of the service provider to complete reservations with customers relating to the offer of services; and
one or more marketplace systems, each said marketplace system being associated with a marketplace and including at least one processor, at least one computer network connection and computer program instructions executable by said at least one processor included in said marketplace system that enable said marketplace system to receive via the at least one computer network connection the one or more offers of services from said scheduling agent system, present the customers the one or more offers of services, receive reservation requests from the customers relating to the one or more offers of services, and communicate received reservation requests to said scheduling agent system;
wherein said computer program instructions executable by said at least one processor of said scheduling agent system further enable said scheduling agent system to conduct a reservation process wherein said scheduling agent system communicates the one or more offers of services from said one or more service offering systems to said one or more marketplace systems to provide a connection among the service providers and marketplaces by which marketplaces are provided schedulable time periods relating to services from multiple service providers and wherein said scheduling agent system processes reservation requests received from said one or more marketplace systems to transform the requests into reservations for services provided by the service providers to the customers.

2. The system of claim 1 wherein a service offered by the one or more service providers comprises an arrangement wherein a customer receives the use of a resource from a service provider.

3. The system of claim 2 wherein the customer receives use of the resource for a scheduled period of time.

4. The system of claim 2 wherein the service provider maintains ownership of the resource during the service.

5. The system of claim 2 wherein the resource comprises a good.

6. The system of claim 2 wherein the resource comprises an activity that is performed.

7. The system of claim 6 wherein at least a portion of the activity is performed by one or more individuals.

8. The system of claim 6 wherein at least a portion of the activity is performed by a device.

9. The system of claim 1 further comprising:
one or more service interface brokers, each said service interface broker corresponding with one of said service offering systems and being enabled to connect said corresponding service offering system with said scheduling agent system for communication there between via a computer network.

10. The system of claim 1 further comprising:
one or more marketplace interface brokers, each said marketplace interface broker corresponding with one of said one or more marketplace systems and being enabled to connect said corresponding marketplace system with said scheduling agent system for communication there between via a computer network.

11. The system of claim 1 further comprising:
at least one media interface providing at least one-way communication from said one or more marketplace systems to the customers, wherein the offers of services available for reservation are communicated from said one or more marketplace systems to the customers via said at least one media interface.

12. The system of claim 11 wherein said at least one media interface provides two-way communication between said one or more marketplace systems and the customers, wherein the reservation requests are communicated from the customers to said one or more marketplace systems via the same said at least one media interface.

13. The system of claim 11 further comprising:
at least one additional media interface providing at least return channel communication from the customers to said one or more marketplace systems, wherein the reservation requests are communicated from the customers to said one or more marketplace systems via said at least one additional media interface.

14. The system of claim 1 further comprising:
at least one media interface enabling two-way communication between said one or more service offering systems and the service providers, wherein the at least one media interface enables operation of said one or more service offering systems by the service providers to define offers of services available for reservation.

15. The system of claim 1 wherein the service providers directly control operation of said one or more service offering systems to define offers of services available for reservation.

16. The system of claim 1 wherein said computer program instructions of said scheduling agent system enable said scheduling agent system to complete reservation requests received from said one or more marketplace systems for offers of services including information indicating that said scheduling agent system is delegated authority to complete reservations.

17. The system of claim 1 wherein at least one offer of services includes information indicating that said scheduling agent system is not delegated authority to complete reservations relating thereto, and wherein said computer program instructions of said scheduling agent system enable said scheduling agent system to inform the service providers about the reservation requests for which said scheduling agent system is not delegated authority to complete through said one or more service offering systems.

18. The system of claim 1 wherein said system includes only a single scheduling agent system communicating offers of services from a plurality of service offering systems to a plurality of marketplace systems and processing reservation requests received from said plurality of marketplace systems.

19. A method for facilitating reservations of services between customers and service providers, said method comprising the steps of:
(a) conducting an offer construction process involving one or more service providers and a scheduling agent supplier, wherein the one or more service providers offer services available for reservation by customers using a services offering system and wherein the scheduling agent supplier provides a scheduling agent system to which offers of services are communicated, wherein the services offering system includes at least one processor, at least one computer network connection and computer program instructions executable by said at least one processor included in the services offering system, and wherein the scheduling agent system includes at least one processor, at least one computer network connection and computer program instructions executable by said at least one processor included in said scheduling agent system that enable said scheduling agent to receive the offers of services via the computer network connection;
(b) conducting a marketplace construction process involving one or more marketplace suppliers and the scheduling agent supplier, wherein the one or more marketplace suppliers provide one or more marketplace systems and one or more media for customer communication with the marketplace systems, wherein each said marketplace system is associated with a marketplace and includes at least one processor, at least one computer network connection and computer program instructions executable by said at least one processor included in said marketplace system that enable said marketplace system to receive via the at least one computer network connection the offers of services from said scheduling agent system, present the customers the offers of services, receive reservation requests from the customers relating to the offers of services, and communicate received reservation requests to said scheduling agent system; and
(c) conducting a reservation process wherein a single scheduling agent system operating separately from the one or more marketplace systems provides a connection among the service providers and marketplaces by which marketplaces are provided schedulable time periods relating to services from multiple service providers and processes reservation requests from customers relating to services offered by the one or more service providers on the one or more marketplace systems and presented to the customers through the one or more media to transform the requests into reservations for services provided by the service providers to the customers.

20. The method of claim 19 wherein a service offered by the one or more service providers comprises an arrangement wherein a customer receives the use of a resource from a service provider.

21. The method of claim 20 wherein the customer receives use of the resource for a scheduled period of time.

22. The method of claim 20 wherein the service provider maintains ownership of the resource during the service.

23. The method of claim 20 wherein the resource comprises a good.

24. The method of claim 20 wherein the resource comprises an activity that is performed.

25. The method of claim 24 wherein at least a portion of the activity is performed by one or more individuals.

26. The method of claim 24 wherein at least a portion of the activity is performed by a device.

27. The method of claim 19 wherein said step of conducting an offer construction process comprises executing computer program instructions that enable the processors of the scheduling agent system and services offering system to:
(i) define one or more offers of services available for reservation with customers, wherein the one or more offers are defined by the one or more service providers and are included in one or more business domains;
(ii) create delegations by the one or more service providers related to the one or more offers, wherein a delegation specifies whether the scheduling agent has authority on behalf of a service provider to complete a reservation relating to an offer; and
(iii) place the one or more offers and related delegations with the scheduling agent system.

28. The method of claim 27 wherein said step of conducting a marketplace construction process comprises executing computer program instructions that enable the processors of the scheduling agent system and marketplace system to:
(i) establish communication between the one or more marketplaces and the scheduling agent system;
(ii) receive information about business domains available to the scheduling agent;
(iii) select at least one business domain; and
(iv) provide information from the one or more marketplace systems through the one or more media to customers about the offers available in the at least one business domain.

29. The method of claim 28 wherein said step of conducting a reservation process comprises executing computer program instructions that enable the processors of the scheduling agent system, marketplace system and services offering system to:
(i) receive at a marketplace a reservation request from a customer relating to an offer of services defined by a service provider;
(ii) transmit the reservation request from the marketplace to the scheduling agent;
(iii) complete the reservation request at the scheduling agent when the scheduling agent is delegated authority by the service provider to complete reservations relating to the offer of services; and
(iv) inform the service provider of the reservation request when the scheduling agent is not delegated authority by the service provider to complete reservations relating to the offer of services.

30. The method of claim 27 wherein said step of conducting a reservation process comprises executing computer program instructions that enable the processors of the scheduling agent system, marketplace system and services offering system to:
(i) receive at a marketplace a reservation request from a customer relating to an offer of services defined by a service provider;
(ii) transmit the reservation request from the marketplace to the scheduling agent;
(iii) complete the reservation request at the scheduling agent system when the scheduling agent system is delegated authority by the service provider to complete reservations relating to the offer of services; and
(iv) inform the service provider of the reservation request when the scheduling agent system is not delegated authority by the service provider to complete reservations relating to the offer of services.

31. The method of claim 19 wherein said step of conducting a marketplace construction process comprises executing computer program instructions that enable the processors of the scheduling agent system and marketplace system to:
(i) establish communication between the one or more marketplaces and the scheduling agent;
(ii) receive information about business domains available to the scheduling agent;
(iii) select at least one business domain; and
(iv) provide information from the one or more marketplaces through the one or more media to customers about the offers available in the at least one business domain.

32. The method of claim 31 wherein said step of conducting a reservation process comprises executing computer program instructions that enable the processors of the scheduling agent system, marketplace system and services offering system to:
(i) receive at a marketplace a reservation request from a customer relating to an offer of services defined by a service provider;
(ii) transmit the reservation request from the marketplace to the scheduling agent;
(iii) complete the reservation request at the scheduling agent when the scheduling agent is delegated authority by the service provider to complete reservations relating to the offer of services; and
(iv) inform the service provider of the reservation request when the scheduling agent is not delegated authority by the service provider to complete reservations relating to the offer of services.

33. The method of claim 19 wherein said step of conducting a reservation process comprises executing computer program instructions that enable the processors of the scheduling agent system, marketplace system and services offering system to:
(i) receive at a marketplace a reservation request from a customer relating to an offer of services defined by a service provider;
(ii) transmit the reservation request from the marketplace to the scheduling agent;
(iii) complete the reservation request at the scheduling agent when the scheduling agent is delegated authority by the service provider to complete reservations relating to the offer of services; and
(iv) inform the service provider of the reservation request when the scheduling agent is not delegated authority by the service provider to complete reservations relating to the offer of services.

34. The method of claim 19 wherein an individual or entity acting as the scheduling agent supplier is separate from each individual or entity acting as a marketplace supplier.

35. The method of claim 19 wherein an individual or entity acting as the scheduling agent supplier is separate from each individual or entity acting as a service provider.

36. The method of claim 19 wherein an individual or entity acting as the scheduling agent supplier is separate from each individual or entity acting as a customer.
